(19) United States
(12) Patent Application Publication
(10) Pub. No.: US 2005/0125489 A1
(43) Pub. Date: Jun. 9, 2005

(54) System and method for determining messages on a server as relating to at least one functional component of a client system

(76) Inventor: David H. Hanes, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/723,482

(22) Filed: Nov. 26, 2003

(51) Int. Cl. G06F 15/16; G06F 9/44

(52) U.S. Cl. 709/202; 709/203; 717/173

(57) ABSTRACT

In at least one embodiment, a system comprises a client system including a plurality of functional components. The system further comprises an agent executing in the client system for accessing a server and determining if any messages identified as relating to at least one of the plurality of functional components are available, wherein if a message identified as relating to at least one of the plurality of functional components is available, the agent causing such message to be output.

### DESCRIPTION OF RELATED ART

Software is a general term for the various kinds of programs used to operate computers and related devices, while the term “hardware” describes the physical aspects of computers and related devices. Software is often divided into application software and system software (which includes operating systems and any program that supports application software).

“Firmware” (or “microcode”) generally comprises software (programs or data) that has been written onto read-only memory (ROM), such as programmable read-only memory (PROM), thus becoming a permanent part of a computing device. Firmware is typically created and tested like software. Once created, it can be distributed like software and, using a special user interface, installed in the PROM by a user. Accordingly, firmware is a combination of software and hardware. That is, ROMs, PROMs and erasable PROMs (EPROMs) that have data or programs recorded on them are considered firmware.

Firmware is often implemented for printers, modems, digital cameras, personal digital assistants (PDAs), optical drives (e.g., CDROM drive, CD-rewriteable (CD-RW) drive, DVDROM drive, DVD-writer drive, DVD-rewritable (DVD-RW), etc.), and other peripheral devices. Firmware is often installed on a peripheral device for controlling certain functionality of the peripheral device. For instance, firmware may be installed on a CD-rewriteable (CD-RW) drive for controlling such things as the servos, cyclic redundancy checking (CRC) generator, and laser power output of the CD-RW drive. The firmware may, in some instances, control how the peripheral device is to respond to instructions received from a host computer to which the peripheral is communicatively coupled.

Additionally, firmware is often included on host computer systems, such as personal computers (PCs), laptops, etc. Such firmware may be included, for instance, for the host computer's processor to control the functionality of the processor (e.g., to control how such processor interacts with other components of the host computer, such as the host computer's operating system (OS)).

New versions of firmware are often created to improve the functionality of an associated device (e.g., to optimize the device's operation, to fix a bug, to add new features, etc.). Traditionally, users have had the burden of keeping track of the versions of firmware installed on their systems (e.g., host computers and peripheral devices) and ensuring that they have the most current version available. For instance, a user determines the version of firmware that is currently loaded on the user's peripheral device or host computer, and the user may periodically check the manufacturer's website to determine if the manufacturer of the peripheral device or host computer is announcing a firmware update that is available for those devices.

### BRIEF SUMMARY OF THE INVENTION

In at least one embodiment, a system comprises a client system including a plurality of functional components. The system further comprises an agent executing in the client system for accessing a server and determining if any messages identified as relating to at least one of the plurality of functional components are available, wherein if a message identified as relating to at least one of the plurality of functional components is available, the agent causing such message to be output.

In at least one embodiment, a system comprises a client system that is at least temporarily communicatively coupled via a communication network to a server system, wherein the client system comprises at least one firmware component. The system further comprises an agent executing on the client system for determining from information on the server system if any updates are available for the at least one firmware component.

In at least one embodiment, computer-executable software code stored to a computer-readable media is provided. The computer-executable software code comprises code for accessing a server system and determining if any updates are available for firmware that is present on a client system. The computer-executable software code further comprises code for outputting notification on the client system that an update is available for the firmware, if determined that an update is available for the firmware.

In at least one embodiment, a method comprises storing a message to a server system. The method further comprises associating information with the message identifying at least one component that is to trigger presentation of the message, and determining, by an agent on a client system, from the information if any messages are available that are identified as being triggered for a component present on the client system.

In at least one embodiment, a method comprises an agent on a client system accessing information on a server system. The method further comprises determining, by the agent, from said information, whether an update is available for firmware on the client system. If determined that an update is available for firmware on the client system, the agent causing notification of said update to be output on the client system.

In at least one embodiment, a client system comprises a plurality of functional means. The client system further comprises means for accessing update information on a server system. The client system further comprises means for determining from the update information whether an update is available for any of the functional means of the client system, and means for providing notification on the client system of an update determined to be available for any of the functional means of the client system.

In at least one embodiment, a method for distributing messages to a plurality of clients to whom the messages relate is provided. The method comprises storing the messages on a server. The method further comprises associating a trigger criteria with each message, wherein the trigger criteria identifies at least one functional component to which the message relates, and distributing an agent to the plurality of clients, wherein the agent is operable to periodically access the server and determine any messages for which the agent's respective client possesses the at least one functional component as specified by the message's associated triggering criteria.

### BRIEF DESCRIPTION OF THE DRAWINGS

FIG. 1 shows an example system for providing notification of a firmware update in accordance with one embodiment;

FIG. 2 shows an example interface that may be displayed on the example system of FIG. 1;

FIG. 3 shows an example client system that includes a connection agent for determining whether the client system has a connection with a communication network;

FIG. 4 shows an operational flow diagram for one implementation of an agent in the example embodiment of FIG. 1;

FIG. 5 shows an example system for providing a client system with notification of a firmware update in accordance with another embodiment;

FIG. 6 shows an operational flow diagram for one implementation of an agent in the example embodiment of FIG. 5;

FIG. 7 shows an example system for providing any of a plurality of different types of messages that are related to one or more components of a client system in accordance with one embodiment;

FIG. 8 shows an operational flow diagram for one implementation of an agent in the example embodiment of FIG. 7;

FIG. 9 shows an example system in accordance with one embodiment that enables a supplier to specify messages that are selectively generated on client systems having triggering component(s); and

FIG. 10 shows an operational flow diagram for suppliers in supplying component-related messages to the appropriate client systems to which the messages pertain in accordance with one embodiment.

### DETAILED DESCRIPTION

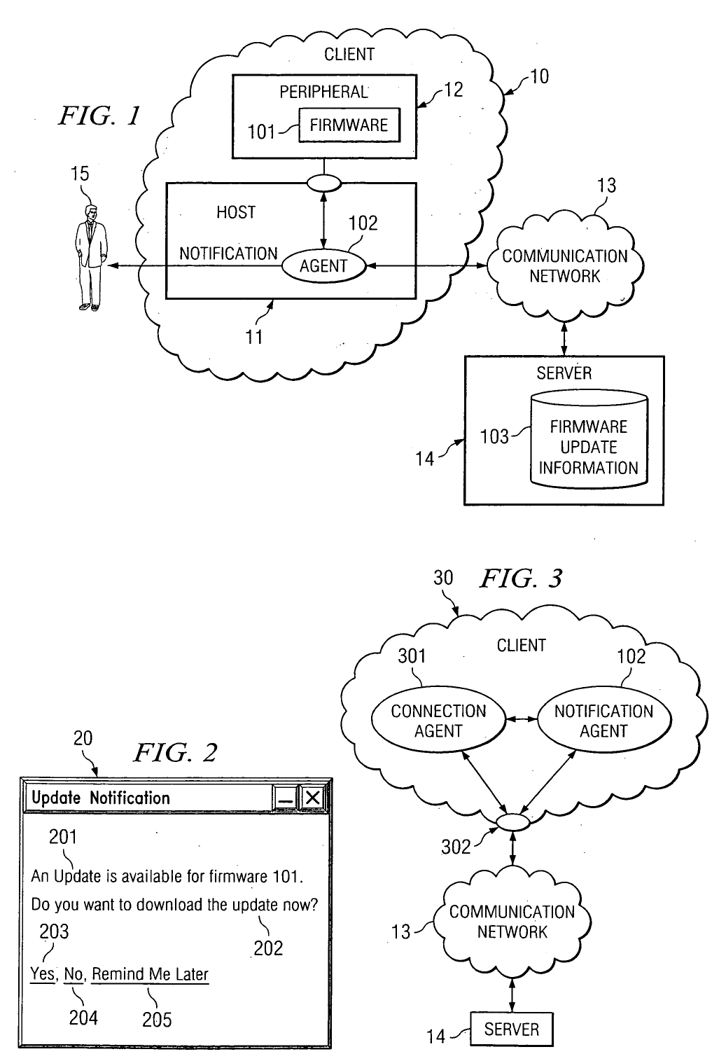

Turning to FIG. 1, an example system for providing notification of a firmware update in accordance with one embodiment is shown. In this example embodiment, a client system 10 is capable of communicatively coupling, at least temporarily, to communication network 13 for accessing server 14, which is also communicatively coupled to communication network 13. Client system 10 comprises a host computing device 11 and a peripheral device 12 that is communicatively coupled to host computing device 11. In this example, peripheral device 12 includes firmware 101. Host computing device 11 comprises an agent 102 (which may be referred to herein as a notification or messenger agent). Server 14 includes database 103 having firmware update information stored thereto. For instance, such firmware update information may identify the most recent version of firmware 101 that is available, and in certain implementations it may include a link to a site for downloading such most recent version.

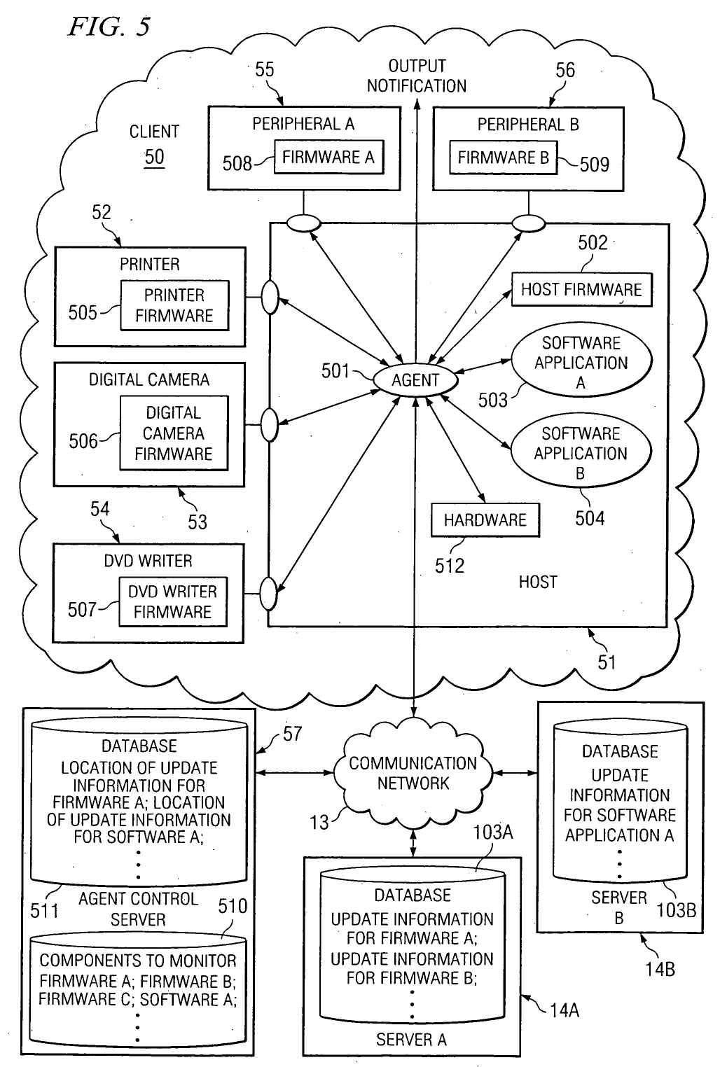

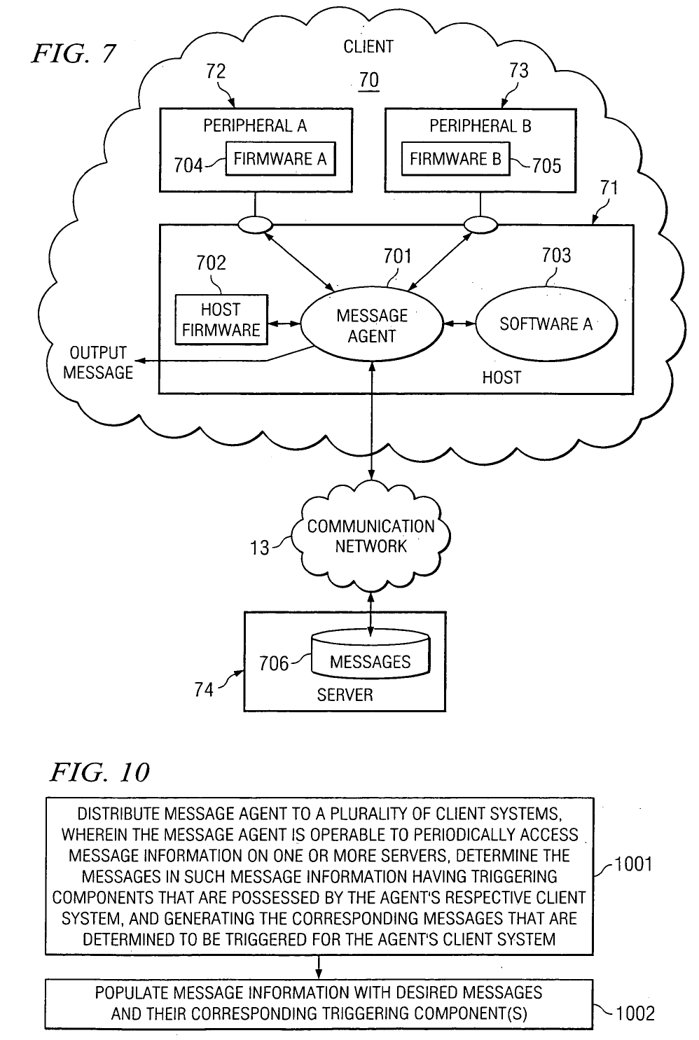

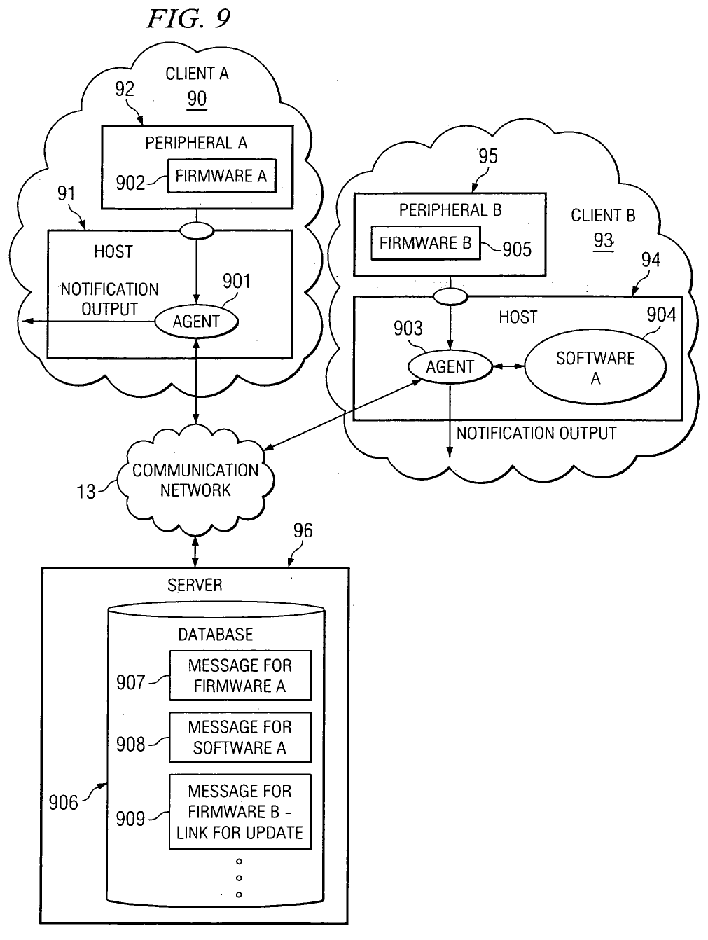

Agent 102 is a non-human agent. For instance, in the example embodiment of FIG. 1, agent 102 includes logic (software and/or hardware) for performing the processes described further below. Similarly, agents 301, (FIG. 3), 501 (FIG. 5), 701 (FIG. 7), and 901 and 903 (FIG. 9) are non-human. Thus, as used herein, “agent” does not refer to a human, but instead refers to logic (e.g., software and/or hardware). In certain implementations, an agent is implemented as a software program (or process) that runs in the background for performing the functions described for such agent.

According to certain embodiments, agent 102 is operable to access firmware update information 103 and to determine whether an update is available for firmware 101 of client system 10. For instance, agent 102 may determine whether firmware 101 corresponds to the most recent version identified in firmware update information 103, and if not, agent 102 may output notification that an update is available for firmware 101. In some implementations, agent 102 may output such notification to a user 15 of client system 10 via a display, printer, audio speaker, and/or other output device (including the peripheral to which the update information 103 relates). In other implementations, agent 102 may output such notification to a file, application program, and/or other computing device, as examples, in addition to or instead of outputting such notification to user 15.

Host computing device 11 may comprise any processor-based device that is capable of communicatively coupling, at least temporarily, to communication network 13. Examples of host computing device 11 include, but are not limited to, a PC, laptop, workstation, personal digital assistant (PDA), cellular telephone, and any other processor-based device capable of at least temporarily coupling to communication network 13. In the example of FIG. 1, computing device 11 is capable of communicatively coupling to a peripheral device 12. Peripheral device 12 may comprise any device that is capable of at least temporarily communicatively coupling to a host computing device 11, including without limitation a printer, fax machine, photocopier, optical scanner, modem, tape drive, optical drive (e.g., CD-RW drive, DVD writer drive, etc.), magnetic storage drive, digital camera, PDA, cellular telephone, MP3 (MPEG-1 Audio Layer-3) player, and joystick.

In certain embodiments, a device may be a peripheral device 12 in certain situations and in other situations be a host computing device 11. For instance, a PDA that is capable of coupling to communication network 13 may also be capable of coupling to a PC that is capable of coupling to communication network 13. The PDA may function as a host device 111 in some situations (e.g., when the PDA is communicatively coupling to communication network 13). Such PDA may have peripherals attached thereto, such as a keyboard, modem, printer, etc. In this scenario, the PDA operates as host 11 to receive information from server 14 as described further herein (e.g., to receive information relating to itself, such as its own firmware, or to receive information relating to one or more of its peripherals, such as firmware for such peripherals). In other situations, the PDA is considered as a peripheral to a host computing device. For instance, the PDA may be communicatively coupled to a PC (e.g., for synchronizing its calendar and other information with the PC), in which case the PC operates as host computing device 11 to receive information from server 14 as described further herein (e.g., to receive information relating to itself, such as its own firmware, or to receive information relating to one or more of its peripherals, such as the PDA).

Server 14 comprises any processor-based device, including, without limitation, a PC that is capable of communicatively coupling to communication network 13 and serving information, such as firmware update information 103, to a client system 10. Communication network 13 may comprise, as examples, the Internet or other Wide Area Network (WAN), an Intranet, Local Area Network (LAN), wireless network, Public (or private) Switched Telephony Network (PSTN), a combination of the above, or any other communications network now known or later developed within the networking arts that enables two or more computing devices to communicate with each other.

Table 1 below shows an example of firmware update information that may be included in database 103 according to one embodiment.

TABLE 1

| | Most Recent | |
|---|---|---|
| Device/Firmware | Version of | |
| ID | Firmware | Link to Most Recent Version |
| “Firmware 101” | Version 3.6 | http://www.version3.6_firmware_101 |
| . . . | . . . | . . . |

Table 1 includes the following fields (or columns): 1) device/firmware identification (ID), 2) most recent version of firmware, and 3) link to most recent version. The firmware ID field includes information identifying a particular firmware, such as the firmware name, product code, etc. or a particular device with which that firmware is associated, such as a specific DVD writer model, printer model, etc. In this example, the name “Firmware 101”, which corresponds to the firmware of peripheral device 12 in FIG. 1, is provided. The most recent version of firmware field includes information identifying the most recent (or current) version of the corresponding firmware (i.e., the firmware identified in column 1 of the corresponding row). For instance, in the above example of Table 1, version 3.6 is identified as the most recent version of firmware available for “Firmware 101.” The link to most recent version field provides information regarding how the most recent version may be obtained, which in this example provides a hypertext link to a website from which the most recent version (version 3.6) may be downloaded and/or otherwise obtained (e.g., via mail order, etc.).

In the example embodiment of FIG. 1, agent 102 is a software process that is running on host computer 11. Agent 102 may be installed on host computer 11 during the installation of peripheral 12, for example. For instance, certain software may be installed on host computer 11 when initially coupling peripheral 12 to host computer 11, such as device drivers, etc., and agent 102 may be included in the software that is installed on host computer 11 during that process. In this manner, agent 102 may be installed on host computer 11 for monitoring for updates to firmware 101 of peripheral 12 as described further below. In certain embodiments, agent 102 may be installed for executing on peripheral 12 rather than or in addition to host computer 11 (e.g., agent 102 may be distributed among host computer 11 and one or more peripheral devices, such as peripheral 12).

Agent 102 periodically accesses server 14 and retrieves firmware update information 103 via communication network 13. Agent 102 analyzes the retrieved firmware update information 103 to determine whether an update is available for firmware 101. For instance, assuming that firmware update information 103 comprises the information shown above in Table 1, agent 102 identifies from such information that the most current version for firmware 101 is version 3.6. Agent 102 determines whether the current version of firmware 101 is version 3.6, or whether such version is an earlier version. If determined that the current version of firmware 101 possessed by peripheral 12 is version 3.6, agent 102 takes no further action. However, in certain implementations, if determined that the current version of firmware 101 possessed by peripheral 12 is not the most recent version 3.6, agent 102 generates an update notification to user 15 and/or to an application program, file, etc., specifying that a more recent version of firmware 101 than that possessed by peripheral 12 is available. For example, output may be displayed to a display (or otherwise output, e.g., via printing to a printer, etc.) informing user 15 that an update is available for firmware 101. Further, in certain embodiments, agent 102 includes in such notification the received information about how to obtain the update, such as a hyperlink to the website identified in the firmware update information of Table 1. Further, agent 102 is, in certain implementations, capable of running a firmware upgrade program after a download is complete, so as to upgrade the corresponding firmware with the downloaded update.

In certain implementations, instead of or in addition to notifying that a user that an update is available, agent 102 automatically accesses an update not possessed by the client system and installs it to the client system. For instance, in certain implementations, a user can set default instructions for agent 102 to instruct agent 102 whether to automatically download an update for peripheral 12 that it determines is not possessed by the client system and install such update for peripheral 12. After automatically downloading and installing such an update to the client system, agent 102 may output notification to a user that peripheral 12 has been automatically upgraded with the update.

FIG. 2 shows an example interface 20 (e.g., window) that agent 102 caused to be displayed on a display responsive to detecting that firmware 101 possessed by peripheral 12 is not the most recent version of such firmware (e.g., is not version 3.6 in the example of Table 1). As shown, interface 20 includes notification 201 that notifies user 15 that an update is available for firmware 101 (or that firmware 101 possessed by peripheral 12 is not the most recent version of such firmware). Interface 20 also includes interactive portion 202 for receiving input from user 15 specifying whether the user would like to download the update. In this example, a “Yes” link 203 may be selected (e.g., by clicking on it with an input device, such as a mouse, touching the link on a touch-screen, or otherwise taking an action for selecting the link) by the user to download the most recent version of firmware 101. For instance, in the example of Table 1, responsive to a user clicking on the “Yes” link 203, agent 102 directs the user's browser to the website identified by the firmware update information 103 as a site from which the most current version may be obtained (e.g., http://www.version3.6_firmware_101 in Table 1). As another example, in certain embodiments, agent 102 is implemented to directly access the specified link to download and/or execute the firmware update rather than accessing the link via the user's browser.

A “No” link 204 may be selected (e.g., by clicking on it with an input device, such as a mouse, touching the link on a touch-screen, or otherwise taking an action for selecting the link) by the user to specify that the user does not want to download the most recent version of firmware 101, in which case agent 102 does not direct the user's browser to the appropriate site for downloading the most recent version. For instance, in some situations the user may want to keep the older version of firmware 101, and may do so by clicking “No” link 204. Responsive to the user selecting the “No” link 204, agent 102 does not notify user 15 further regarding this update being available. That is, in certain implementations, agent 102 maintains data indicating that the user has been notified of this specific notification and should not be notified further or again. Accordingly, the next time that agent 102 retrieves firmware update information 103 and determines that firmware 101 is not the current version 3.6, agent 102 determines that another notification of this should not be provided to user 15. However, if a next version (e.g., version 3.7) of which the user has not been notified is determined as being available, agent 102 may notify the user regarding this new update. In certain implementations, a user can disable all further notifications by agent 102 of updates (or other messages, as described below) for one or more peripherals, such as peripheral 12, whereby agent 102 does not provide any further notifications related to such peripheral(s) unless/until the user re-enables such notifications for the particular peripheral(s).

Further, a “Remind Me Later” link 205 may be selected (e.g., by clicking on it with an input device, such as a mouse, touching the link on a touch-screen, or otherwise taking an action for selecting the link) by the user to specify that the user does not want to download the most recent version of firmware 101 at this time but wants to be reminded about the update at a later time. If the user selects the “Remind Me Later” link 205, agent 102 provides this notification to the user again at a later time.

In one embodiment, agent 102 determines whether host computing device 11 has a communication connection to communication network 13 before attempting to access server 14. That is, rather than attempting to actively establish a communication link to network 13 for accessing server 14, agent 102 waits until host computing device 11 has an active communication connection to communication network 13 before it attempts to access server 14. For instance, host computing device 11 may have dial-up access to the Internet via a telephone modem, and agent 102 may monitor host computing device 11 to determine when it is accessing the Internet before attempting to access server 14. Further, while a user is accessing other portions of communication network 13 (e.g., browsing other websites, etc.), agent 102 retrieves firmware update information 103 from server 14 in the background (e.g., without the user being aware of such information retrieval).

FIG. 3 shows an example client system 30 that includes agent 102 (referred to here as a “notification agent”) and connection agent 301. Connection agent 301 monitors communication port 302, which is a communication port used by client system 30 for communicatively accessing communication network 13, to detect whether client system 30 is communicatively coupled to such communication network 13. Connection agent 301 notifies notification agent 102 regarding whether client system 30 is connected to communication network 13, and notification agent 102 uses this information to determine when to attempt to access server 14. For instance, upon detecting that client system 30 is connected to communication network 13, connection agent 301 notifies notification agent 102 of such connection, and notification agent 102 determines whether retrieval of firmware update information 103 should be performed (e.g., agent 102 determines whether a pre-defined time interval has elapsed since the previous retrieval of such firmware update information). If agent 102 determines that such a retrieval should be performed while client system 30 is connected to network 13, notification agent 102 accesses server 14 and retrieves the firmware update information 103. Upon detecting that client system 30 is no longer connected to communication network 13, connection agent 301 notifies notification agent 102 of such lost connection, and notification agent 102 waits until being notified of a new connection to communication network 13 before attempting to access server 14 and retrieving the firmware update information 103.

In other embodiments, agent 102 attempts to actively couple to communication network 13, particularly if host computing device 11 is capable of establishing such a connection without interrupting other activities of the user. For instance, if host computing device has broadband cable or digital subscriber line (DSL) Internet connectivity, as opposed to dial-up service (in which attempting to connect to the Internet may interrupt/disturb the user's utilization of the telephone line), agent 102 attempts, in certain embodiments, to actively establish connection to communication network 13. Further, in certain embodiments, agent 102 is configurable to attempt to actively establish connection to communication network 13 at select times that are unlikely to interfere with the user's other activities. For instance, a user may, in certain implementations, configure agent 102 to attempt to establish connection to communication network 13 at a particular time of day that is unlikely to interfere with any other activity of the user, such as during a time when the user is typically sleeping.

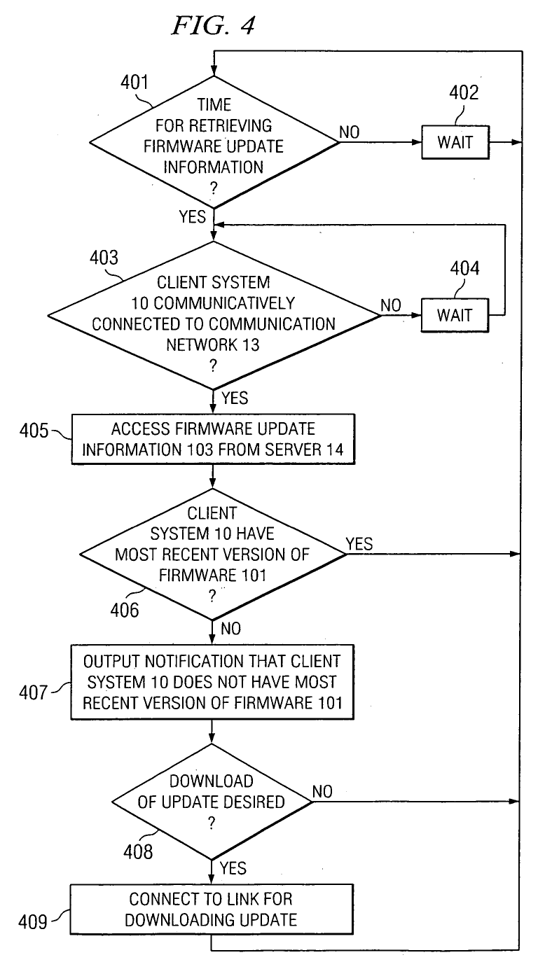

FIG. 4 shows an operational flow diagram for one implementation of agent 102 in the example embodiment of FIG. 1. In operational block 401, agent 102 determines whether it is time for retrieving firmware update information 103. For instance, agent 102 may periodically (e.g., after a defined time elapse) access such firmware update information 103 for client system 10. If determined that it is not time for accessing firmware update information 103, agent 102 waits in block 402 and returns to block 401 after an elapsed waiting time. Once agent 102 determines in block 401 that it is time for accessing firmware update information 103, operation advances to block 403 whereat agent 102 determines whether client system 10 is communicatively connected to communication network 13. For instance, connection agent 301 of FIG. 3 determines whether client system 10 is connected to communication network 13, and informs agent 102 in this regard. If client system 10 is not connected to communication network 13, agent 102 waits in block 404 and then returns to block 403 after an elapsed waiting time.

Once agent 102 determines in block 403 that client system 10 is communicatively connected to network 13, operation advances to block 405 whereat agent 102 accesses firmware update information 103 from server 14. In operational block 406, agent 102 uses the firmware update information 103 to determine whether client system 10 has the most recent version of firmware 101. For instance, in the example of FIG. 1, agent 102 determines the version of firmware 101 currently possessed by peripheral 12, and agent 102 then determines whether the version of firmware 101 currently possessed by peripheral 12 is identified by firmware update information 103 as being the most recent version of such firmware 101 that is available. If determined in block 406 that the most recent version of firmware 101 is possessed by client system 10, operation of agent 102 returns to block 401.

If agent 102 determines in block 406 that client system 10 (e.g., peripheral 12) does not possess the most recent version of firmware 101, then agent 102 outputs notification of this fact in block 407. Of course, as described in connection with FIG. 2 above, in some implementations agent 102 may not repeatedly output notification of a more recent version of firmware 101 being available. For instance, if agent 102 had already notified user 15 of the more recent version of firmware 101 being available via the example interface 20, and user 15 had selected “No” link 204, then agent 102 may not output this notification again in block 407. Further, as described in connection with FIG. 2 above, in certain implementations the user may select to be reminded later of this update (e.g., by selecting Remind Me Later link 205), wherein agent 102 provides notification of this update again at a later time.

In block 408, agent 102 determines whether user 15 desires to download the most recent version of firmware 101. If not, operation of agent 102 returns to block 401. On the other hand, if the updated version of firmware 101 is desired by user 15, agent 102, in block 409, connects client system 10 to a link (which may be specified in the firmware update information 103) for downloading the updated version. In certain implementations, agent 102 downloads and runs/installs the updated version of firmware 101. Operation then returns to block 401.

Turning to FIG. 5, an example system for providing a client system with notification of a firmware update in accordance with another embodiment is shown. In this example embodiment, a client system 50, which is analogous to client system 10 of FIG. 1, is capable of communicatively coupling, at least temporarily, to communication network 13 for accessing servers 14_{A} and 14_{B} (which are each analogous to server 14 of FIG. 1) that are also communicatively coupled to communication network 13. Client system 50 comprises a host computing device 51 (which is analogous to host computing device 11 of FIG. 1) and peripheral devices 52-56 that are communicatively coupled to host computing device 51. In this example, peripheral device 52 is a printer, peripheral device 53 is a digital camera, peripheral device 54 is a DVD writer drive, and peripheral devices 55 and 56 are other types of peripheral devices. Printer 52 includes firmware 505. Digital camera 53 includes firmware 506. DVD writer 54 includes firmware 507. Similarly, peripheral A 55 includes corresponding firmware 508, and peripheral B 56 includes corresponding firmware 509.

Host computing device 51 comprises an agent 501. Agent 501 may be referred to herein as a general-purpose notification agent because in certain implementations it is capable of providing notification of updates that are available for any of many different types of components that may be included in client system 50, as described further below. Host computing device 51 also comprises host firmware 502 (e.g., firmware for the host computing device's microprocessor). Host computing device 51 also comprises software application A 503 and software application B 504. Software applications A 503 and B 504, as well as agent 501, are, in certain implementations, arranged local to host computing device 51 (e.g., stored to host computing device 51), while in other implementations one or more of software applications A 503, B 504, and agent 501 are arranged (in part or in whole) remote from host computing device 51 and are accessible by host computing device (e.g., via a communication network, such as communication network 13).

In this example, server 14_{A} includes database 103_{A} having component update information stored thereto, such as update information for firmware A 508 and update information for firmware B 509. Similarly, server 14_{B} includes database 103_{B} having component update information stored thereto, such as update information for software Application A 503. For instance, such component update information may identify the most recent version of a corresponding component (e.g., firmware or software) that is available, and in certain implementations it may include a link to a site for downloading such most recent version. While two servers that comprise component update information are shown in FIG. 5, any number of such servers may be implemented in accordance with this embodiment.

According to certain embodiments, agent 501 is operable to determine various components that are included in client system 50, such as firmware 502 and 505-509 and software 503-504. As an example, with many peripheral devices, such as optical drives (e.g., CDROM, DVDROM, CD-RW, DVD-writers, DVD-RW, etc.), the firmware of the peripheral can be obtained by issuing an “inquiry” command to the device. This returns a block of data, part of which contains the firmware version. Agent 501 is further operable to access component update information 103_{A}-103_{B} and determine whether an update is available for any of the components that it identifies as being included in client system 50.

Accordingly, agent 501 is not associated with a single component, such as firmware 11 in the example of FIG. 1, but instead monitors for updates that are available for any of a plurality of different components that are included in client system 50. Further, agent 501 is not limited to monitoring firmware, but it also monitors software components that are included in client system 50. Further, in certain embodiments, agent 501 further monitors hardware components, such as hardware 512, that is included in client system 50, and determine if updates are available for such hardware (and providing notification of any such identified updates in a manner similar to that described herein for the firmware and software components of client system 50). For instance, hardware 512 may be memory, a processor, a disk drive, or any other hardware element included in client system 50, and agent 501 may monitor for updates for such hardware element. In response to notification of an updated hardware element being available, a user may purchase (or otherwise acquire) and install such updated hardware element to maintain client system 50 current with the latest hardware available.

In certain implementations, agent 501 is pre-programmed to monitor client system 50 for certain components and, upon detecting any of those components in client system 50, periodically access one or more of server A 14_{A} and server B 14_{B} for determining whether updates are available for the components. In certain implementations, the components themselves are configured to provide information to agent 501 regarding the location of their respective update information. For instance, in certain implementations, software application A 503 contains a link to a website address that agent 501 uses for monitoring for updates for software application A 503.

In other implementations, agent 501 periodically accesses an agent control server 57 to determine the components that it is to monitor for inclusion in client system 50 and/or to determine locations for accessing update information for any such components that are determined to be included in client system 50. For example, agent control server 57 includes database 510 that identifies all components for which agent 501 is to monitor client system 50 to determine whether any one or more of such components are included therein. Further, agent control server 57 includes database 511 that identifies a location from which agent 501 may retrieve update information for each component. In this manner, the monitoring functionality of agent 501 can be dynamically changed by changing the information on agent control server 57. For instance, as new components become available that are desired to be monitored by agent 501, identification of such new components are added in database 510 and their respective network location for accessing their update information are added in database 511. Additionally, if monitoring for updates of a component is no longer desired, such component is removed from database 510.

In the example implementation utilizing agent control server 57, the components to be monitored are not required to be configured to provide agent 501 with a network location for monitoring for their respective updates. Further, in certain implementations, database 511 also contains a method (e.g., instructions) to inform agent 501 how to retrieve the firmware of a specific peripheral. This enables the agent 501 to dynamically find the current firmware revision even if it did not know how to before (e.g., even if it was not pre-programmed with the ability to determine the firmware version of that peripheral). For example, if agent 501 is not pre-programmed with the ability (or “know-how”) to determine the current firmware version possessed by an optical drive, database 511 contains a method for such optical drive that indicates the command(s) to issue and how to interpret the resulting data for determining the current firmware version; agent 501 retrieves that method from database 511 and uses it.

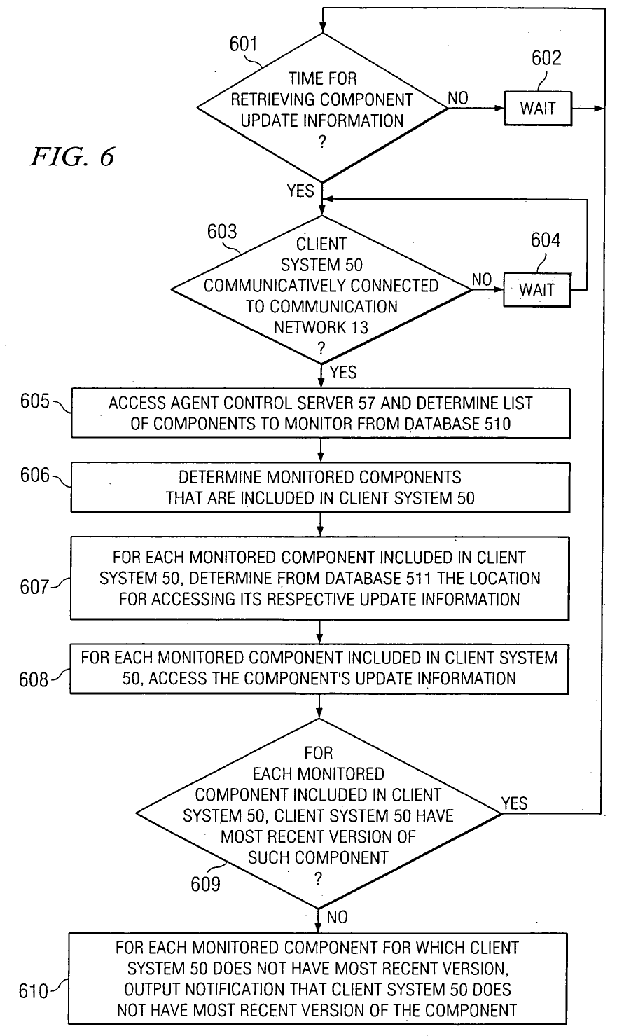

FIG. 6 shows an operational flow diagram for one implementation of agent 501 in the example embodiment of FIG. 5. In operational block 601, agent 501 determines whether it is time for retrieving component update information. For instance, agent 501 periodically (e.g., after a defined time elapse) accesses update information for “monitored” components that are included in client system 50. If determined that it is not time for accessing the component update information, agent 501 waits in block 602 and returns to block 601 after an elapsed waiting time. As described further below, in certain embodiments agent 501 uses a different periodicity for checking the update information for different components.

Once agent 501 determines in block 601 that it is time for accessing component update information, operation advances to block 603 whereat agent 501 determines whether client system 50 is communicatively connected to communication network 13. For instance, connection agent 301 of FIG. 3 determines whether client system 50 is connected to communication network 13, and informs agent 501 in this regard. If client system 50 is not connected to communication network 13, agent 501 waits in block 604 and then returns to block 603 after an elapsed waiting time.

Once agent 501 determines in block 603 that client system 50 is communicatively connected to network 13, operation advances to block 605 whereat agent 501 accesses agent control server 57 and determines from database 510 a list of components to monitor for updates (“monitored components”). In operational block 606, agent 501 determines the ones of the monitored components that are included in client system 50. For instance, database 510 may list firmware component A, firmware component B, firmware component C, software component A, and software component C as monitored components, and for the example client system 50 of FIG. 5, agent 501 determines that such client system 50 includes firmware component A (labeled 508), firmware component B (labeled 509), and software component A (labeled 503) but does not include firmware component C or software component C.

In operational block 607, agent 501 determines from database 511 of agent control server 57 a location for accessing update information for each of the monitored components determined in block 606 as being included in client system 50. For instance, continuing with the above example, agent 501 determines from database 511 the location for accessing update information for each of firmware component A, firmware component B, and software component A. Such location for accessing update information for a monitored component may, for example, be an address for accessing server A 14_{A} or server B 14_{B} of FIG. 5.

In certain embodiments, agent 501 is configurable regarding the periodicity that is to be used for checking for messages (e.g., updates) that are available for each monitored component. Thus, each time that agent 501 accesses database 511, it may not determine the location for accessing update information for all components of the client system. Different monitored components of the client system may have a different periodicity specified by the user that is to be used by agent 501 for monitoring. For instance, agent 501 may be configured for checking for messages (e.g., update information) for certain monitored components once an hour, others once a day, others once a week, still others once a month, and still others once a year.

In operational block 608, agent 501 accesses the respective update information for each monitored component determined in block 606 as being included in client system 50 (e.g., by host device 51 and/or peripheral devices 52-56). And, in operational block 609, agent 501 uses the accessed update information to determine whether client system 50 has the most recent version of each of such monitored components included therein. If determined in block 609 that the most recent version of each monitored component that is included in client system 50 is possessed by client system 50, operation of agent 501 returns to block 601. If, on the other hand, agent 501 determines in block 609 that client system 50 does not possess the most recent version of one or more of its monitored components, then agent 501 outputs notification of this fact in block 610. Of course, as described with FIG. 2 above, in some implementations agent 501 may not repeatedly output notification of a more recent version of a component being available. For instance, if agent 501 had already notified user 15 of the more recent version of a component being available via the example interface 20, and user 15 had selected “No” link 204, then agent 501 may not output this notification again in block 610. Further, as described in connection with FIG. 2 above, in certain implementations the user may select to be reminded later of this update (e.g., by selecting Remind Me Later link 205), wherein agent 501 provides notification of this update again at a later time.

In certain embodiments, agent 501 further performs operations analogous to operations 408 and 409 of FIG. 4. That is, after providing notification of an update being available for a component of client system 50, agent 501 determines whether user 15 desires to download the most recent version of such component, and if the updated version of the component is desired by user 15, agent 501 connects client system 50 to a link (which may be specified in the component update information) for downloading the updated version of such component. Further, in certain implementations, agent 501 is operable to run the downloaded update for updating the corresponding component (e.g., firmware).

While the example embodiments provided above are described as providing notification of updates that are available for components of a client system, certain embodiments may be employed for providing any of many different types of messages that are associated with components of a client system. FIG. 7 shows an example system for providing any of a plurality of different types of messages that are related to one or more components of a client system in accordance with one embodiment. As shown, in this example embodiment, a client system 70, which is analogous to client systems 10 and 50 of FIGS. 1 and 5 respectively, is capable of communicatively coupling, at least temporarily, to communication network 13 for accessing server 74 that is also communicatively coupled to communication network 13. Client system 70 comprises a host computing device 71 (which is analogous to host computing devices 11 and 51 of FIGS. 1 and 5, respectively) and peripheral devices A and B (labeled 72 and 73, respectively) that are communicatively coupled to host computing device 71. Peripheral device A 72 includes corresponding firmware 704, and peripheral B 73 includes corresponding firmware 705.

Host computing device 71 comprises an agent 701. Agent 701 may be referred to herein as a general-purpose message agent because in certain implementations it is capable of providing any of various different types of messages that are related to one or more components of client system 70, such as update notifications (as described above in connection with FIGS. 1-6), advertisements, tips (e.g., for using a component), warnings (e.g., of known bugs/problems of a component), special offers, recall notices, etc. Host computing device 71 also comprises host firmware 702 (e.g., firmware for the host computing device's microprocessor). Host computing device 71 also comprises software application A 703.

In this example, server 74 includes message database 706 having component-related messages stored thereto. Table 2 below provides an example of information that are included in database 706 in certain implementations.

TABLE 2

| Triggering | | | |
|---|---|---|---|
| Component ID(s) | Message | Message Type | Link |
| Component A | A new accessory “X” | Advertisement | http://www.componentA.advertisement |
| | is available for | | |
| | Component A. To | | |
| | obtain more | | |
| | information or | | |
| | purchase accessory | | |
| | “X” visit the | | |
| | following link: | | |
| | {link}. | | |
| Components B OR C | Tip: to review current | Tip/Warning | |
| | user settings for | | |
| | component B or | | |
| | component C, press | | |
| | the “alt-r” keys on | | |
| | those components. | | |
| Component D | Version 2.8 | Update | Http://www.componentD.update |
| Components A AND C | A new accessory “X” | Special Offer | http://www.componentsA_{—} |
| | is available for | | and_C.offer |
| | interfacing | | |
| | Component A | | |
| | directly with | | |
| | Component C. To | | |
| | obtain more | | |
| | information or | | |
| | purchase accessory | | |
| | “X” visit the | | |
| | following link: | | |
| | {link}. | | |
| Component E | Component E is | Recall Notice | http://www.componentE.recall |
| | being recalled by the | | |
| | manufacturer. For | | |
| | more information | | |
| | regarding this recall, | | |
| | visit the following | | |
| | link: {link}. | | |
| . . . | . . . | . . . | . . . |

Table 2 includes the following fields (or columns): 1) triggering component identification(s) (ID(s)) (which may also be referred to herein as “associated component ID”), 2) message, 3) message type, and 4) link. The triggering component ID field includes information identifying a particular component (or components) that if included in the client system 70 is to trigger agent 701 to output the corresponding message. The message field includes a message that is to be output by agent 701 for a corresponding component(s) (i.e., the component(s) identified in column 1 of the corresponding row). The message type field includes information identifying the type of message in the corresponding row, such as an update notification, an advertisement, etc. The link field identifies a network link which may be accessed to obtain further information relating to the message (e.g., to download an update, to purchase an advertised product, etc.). In this example, “{link}” may be used in a message as a tag to notify agent 701 to replace the “{link}” tag with the corresponding link in the message that it outputs.

In the above example of Table 2, the first row identifies a message to be triggered for component A. Thus, if agent 701 discovers that component A is included in client system 70, it generates an output (e.g., to a display, printer, etc.) providing the corresponding message. The message is identified as:
A new accessory “X” is available for Component A. To obtain more information or purchase accessory “X” visit the following link: {link}.
   Because “{link}” acts as a tag, as described above, agent 701 replaces such “{link}” tag with the corresponding link “http://www.componentA.advertisement” in its output message. Thus, if component A is included in client system 70, agent 701 generates the following advertisement message that is output on client system 70:
A new accessory “X” is available for Component A. To obtain more information or purchase accessory “X” visit the following link: http://www.componentA.advertisement.

It should be recognized in this example that the message is not directly related to the triggering component A. Rather, the message is an advertisement for an accessory “X” that may be desirable to users having component A. For instance, component A may be a digital camera, and device “X” may be a photo-printer. Accordingly, messages for a first device (e.g., accessory “X”) can be directed to client systems possessing another device (e.g., component A). Further, logical operands may be used in the triggering components field in certain implementations. For example, to ensure that the advertisement for accessory “X” in the above example is only presented on a client system 70 that includes component A and does not include accessory “X” (i.e., it may not be desirable to present an advertisement to a user for device “X” if the user already has device “X”), the triggering component ID(s) field may be modified to: Component A NOT Component X. Agent 701 is operable to interpret the “Component A NOT Component X” and trigger the corresponding message only if Component A is included in client system 70 and component X is not included in client system 70. Further, agent 701 is also operable to keep track of the messages that it has presented so that it does not continue re-presenting them (unless the user specifies that the agent is to remind him of the message at a later time, as discussed with FIG. 2 above).

Continuing with the above example of Table 2, the second row identifies a message to be triggered for client systems possessing Component B OR Component C. Thus, if either or both of Components B and C are included in client system 70, agent 701 triggers output of the corresponding message. The corresponding message in this example is:
Tip: to review current user settings for component B or component C, press the “alt-r” keys on those components.
   The above message provides a tip to the user for components B and C. More specifically, the above message provides a tip as to how to review the current user settings for those devices.

The third row of Table 2 identifies a message to be triggered for Component D. More specifically, this message is identified as an update, as can be seen in the corresponding “Message Type” column. That is, the message field specifies that Version 2.8 is the most recent version of Component D. Accordingly, agent 701 treats this update message for Component D as described for providing update notifications in the example embodiments of FIGS. 1-7 above. For example, if agent 701 discovers that Component D is included in client system 70, it determines whether the version of Component D possessed by client system 70 is Version 2.8, and if not, it generates an output (e.g., to a display, printer, etc.) notifying the user that such Component D is not the most recent version, as described above with FIG. 2.

It should be recognized that the update type of message is treated differently by agent 701 in this example than were the advertisement and tip/warning types of messages described above. For instance, upon the triggering components being identified in client system 70, agent 701 output the specified messages provided as an advertisement or a tip/warning in the above examples, but the “update” message is used for analysis by agent 701. That is, rather than generating an output message “Version 2.8”, agent 701 recognizes this message as an update type of message (e.g., because of it being identified as such in the Message Type field) and analyzes Component D to determine whether client system 70 possesses such version 2.8, wherein if such version 2.8 is not possessed by client system 70 then agent 701 generates notification of this fact as described above with FIG. 2. Further, the link field may be provided in such notification to enable a user to access the corresponding network location for downloading the updated version 2.8, if so desired.

The fourth row identifies a “Special Offer” type of message that is to be triggered for client systems possessing Components A AND C. Thus, if both of Components A and C are included in client system 70, agent 701 triggers output of the corresponding message. The corresponding message in this example is:
A new accessory “X” is available for interfacing Component A directly with Component C. To obtain more information or purchase accessory “X” visit the following link: {link}.
   Because “{link}” acts as a tag, as described above, agent 701 replaces such “{link}” tag with the corresponding link “http://www.componentsA_and_B.offer” in its output message. Thus, if both components A and C are included in client system 70, agent 701 generates the following advertisement message that is output on client system 70:
A new accessory “X” is available for interfacing Component A directly with Component C. To obtain more information or purchase accessory “X” visit the following link: http://www.componentsA_and_B.offer.

It should be recognized in this example that the message is not directly related to the triggering components A and C. Rather, the message is an advertisement for an accessory “X” that may be desirable to users having components A and C (e.g., to enable them to interface those two components in this example). For instance, component A may be a digital camera, component C may be a photo-printer, and device “X” may be an adapter to allow the digital camera to interface directly with the photo-printer. This message may provide a special offer (e.g., a reduced price, free shipping, etc.) for users already having both components A and C. In this manner, a manufacturer may direct such “special offers” to those users that have purchased other products of the manufacturer, for example. In order to do so, the manufacturer need not maintain a customer list for determining those customers possessing components A and C in order to contact them. Rather, the manufacturer can simply provide the special offer message for the desired triggering components in the message database 706, and agent 701 executing on various client systems, such as client system 70, determines whether the client system satisfies the triggering criteria for presenting the special offer to the user of such client system.

Continuing with the above example of Table 2, the fifth row identifies a “Recall Notice” type of message to be triggered for client systems possessing Component E. Thus, if Component E is included in client system 70, agent 701 triggers output of the corresponding message. The corresponding message in this example is:
Component E is being recalled by the manufacturer. For more information regarding this recall, visit the following link: {link}.
   Again, agent 701 interprets “{link}” as a tag, and replaces it in the generated output message with the corresponding link. This message provides notice of a recall of Component E to the user of a client system possessing such Component E.

Various other types of messages may be defined and recognized by agent 701 in addition to or instead of those described above. Further, in certain embodiments, a user interface is provided to enable a user to configure agent 701 for presenting messages in the manner so desired by the user. For example, a user may not desire to have any advertisement messages presented by agent 701, or the user may wish to only have advertisement messages presented for certain triggering components (e.g., a user may want advertisements relating to the user's digital camera, but not for any other components of the user's system). In certain embodiments, the user can configure agent 701 to tailor one or more of the following features: a) the types of messages that are presented by agent 701 (e.g., present all update messages, but no advertisement messages), b) the components of the system that may be used as triggering components for messages (e.g., permit the printer's firmware of the client system to be used as a triggering component but not the client system's photocopier), and c) how often agent 701 checks for new messages being available (e.g., the user may configure agent 701 to check for messages for certain components of the system more often than it checks for messages for certain other components of the system).

In certain embodiments, agent control server 57 of FIG. 5 may be included for specifying the components monitored by message agent 701, as well as the network locations for accessing each monitored component's respective messages (e.g., messages 706 for different components may be distributed among a plurality of different servers, such as servers 14_{A} and 14_{B} of FIG. 5).

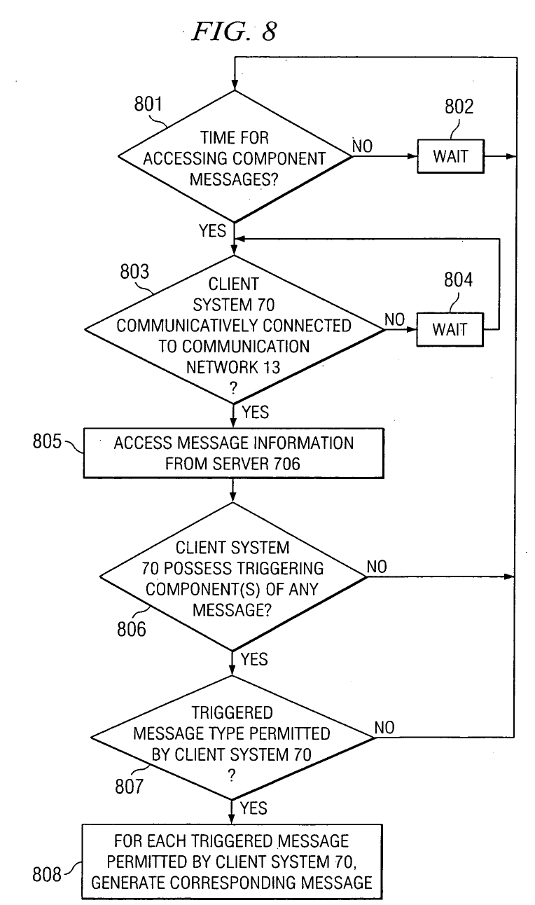

FIG. 8 shows an operational flow diagram for one implementation of agent 701 in the example embodiment of FIG. 7. Operational blocks 801-804 correspond to operational blocks 401-404 of FIG. 4, and therefore are not further described. In operational block 805, agent 701 accesses message information 706 from one or more servers, such as server 74. In operational block 806, agent 701 determines whether client system 70 possesses the triggering components of any of the messages. If not, operation returns to block 801. Otherwise, operation advances to block 807 whereat agent 701 determines whether any of the triggered messages are permitted by client system 70. For instance, as described above, a user may configure agent 701 to permit certain types of messages but not others. For example, a user may not permit any advertisement type of messages to be generated by agent 701. If none of the triggered messages are permitted by client system 70, operation returns to block 801. Otherwise, if one or more of the triggered messages are permitted by client system 70, operation advances to block 808 whereat agent 701 generates a corresponding message for each triggered message that is permitted by client system 70. Further, in certain embodiments, agent 701 then marks a generated message as read or as presented. Accordingly, agent 701 keeps track of those messages that it has presented to a user.

Certain embodiments of the present invention provide an easy and efficient mechanism for suppliers (e.g., manufacturers, etc.) to direct messages, such as advertisements, updates, etc., that are related to triggering components to those client systems having the triggering components. For instance, FIG. 9 shows an example system in accordance with one embodiment that enables a supplier to specify messages that are selectively generated on client systems having the triggering component(s). As shown, in this example embodiment, a plurality of client systems are provided, such as client system A (labeled 90) and client system B (labeled 93), which are each analogous to client system 70 of FIG. 7. Each of client systems 90 and 93 is capable of communicatively coupling, at least temporarily, to communication network 13 for accessing one or more servers, such as server 96, that are also communicatively coupled to communication network 13.

Client system A 90 comprises a host computing device 91 and peripheral device A 92 that is communicatively coupled to host computing device 91. Peripheral device A 92 includes corresponding firmware 902. And, host computing device 91 comprises an agent 901, such as the example agent 701 described above in conjunction with FIG. 7.

Client system B 93 comprises a host computing device 94 and peripheral device B 95 that is communicatively coupled to host computing device 94. Peripheral device B 95 includes corresponding firmware 905. And, host computing device 94 comprises software A 904 and an agent 903, such as the example agent 701 described above in conjunction with FIG. 7.

Server 96 includes message information 906, which may correspond to the message information 706 described above in conjunction with FIG. 7 for example. One or more suppliers (e.g., information suppliers, product suppliers, etc.) store messages in the database 906. For instance, in the example of FIG. 9, message database 906 includes a first message 907 having “Firmware A” as a triggering component (e.g., message 907 is an update, advertisement, or other type of message relating to Firmware A). Message database 906 includes a second message 908 having “Software A” as a triggering component (e.g., message 908 is an update, advertisement, or other type of message relating to Software A). Further, message database 906 includes third message 909 having “Firmware B” as a triggering component (e.g., message 909 is an update, advertisement, or other type of message relating to Firmware B) and further includes a network link for accessing further information related to the message (e.g., for downloading an update, etc.).

In operation of the example system of FIG. 9, a supplier stores to database 906 the messages that it wants to convey to clients having the corresponding triggering components. Agent 901 on client system 90 periodically accesses the message information and determines those messages, if any, that are to be output for such client system 90. For instance, agent 901 determines that client system 90 includes Firmware A (labeled 902), and thus may generate the corresponding message from message information 907 on such client system 90 (assuming that agent 901 has been configured to permit this type of message for client system 90).

Similarly, agent 903 on client system 93 periodically accesses the message information and determines those messages, if any, that are to be output for such client system 93. For instance, agent 903 determines that client system 93 includes Software A 904 and Firmware B 905, and thus may generate the corresponding messages from message information 908 and 909 on such client system 93 (assuming that agent 903 has been configured to permit these types of message for client system 93).

In view of the above, suppliers can store messages to message database 906 on server 96 and rely on the agents operating on various client systems to ensure that the proper ones of those messages are generated on the proper client systems. Accordingly, this provides an easy and efficient technique for providing component-related messages from suppliers to the appropriate client systems to which the messages pertain.

FIG. 10 shows an operational flow diagram for suppliers in supplying component-related messages to the appropriate client systems to which the messages pertain in accordance with one embodiment. In operational block 1001, a message agent, such as the message agent 701 of FIG. 7, is distributed to a plurality of client systems (such as client systems 90 and 93 of FIG. 9). The message agent is operable to periodically access message information on one or more servers (such as message information 906 of server 96 in FIG. 9), determine the messages in such message information having triggering components that are possessed by the agent's respective client system, and generate the corresponding messages that are determined to be triggered for the agent's client system. In operational block 1002, the supplier(s) populate the message information (such as message information 906 of FIG. 9) with desired messages (such as the example messages of Table 2 described above) and identification of each message's corresponding triggering component(s). Accordingly, once the message agents are distributed to a population of client systems, the suppliers need only populate the message information database on a server (such-as server 96 of FIG. 9) with desired messages and identification of corresponding triggering components, and the message agents determine the ones of those messages that are triggered for their respective client systems.

1. A system comprising:
a client system including a plurality of functional components; and
an agent executing in said client system for accessing a server and determining if any messages identified as relating to at least one of said plurality of functional components are available, wherein if a message identified as relating to at least one of said plurality of functional components is available, said agent causing such message to be output.

2. The system of claim 1 wherein said plurality of functional components comprises firmware.

3. The system of claim 1 wherein said plurality of functional components comprises software.

4. The system of claim 1 wherein said plurality of functional components comprises any selected from the group consisting of: firmware, peripheral device, host device, and software.

5. The system of claim 1 wherein at least one of said messages comprise update notification for a corresponding one of said plurality of functional components.

6. The system of claim 1 wherein at least one of said messages comprises an advertisement.

7. The system of claim 1 wherein at least one of said messages has associated type information that identifies a type of the corresponding message.

8. The system of claim 7 wherein said type comprises any selected from the group consisting of: an update notification, an advertisement, a tip, a warning, a special offer, and a recall notice.

9. The system of claim 1 wherein said agent is configurable to determine whether to present a message identified as relating to at least one of said plurality of functional components based at least in part on a corresponding message type.

10. The system of claim 1 wherein said agent is further operable to access a separate server to determine at least one network location for accessing said messages for at least one of the plurality of firmware components.

11. The system of claim 1 wherein at least one of said messages has a triggering criteria associated therewith, said triggering criteria identifying at least one functional component to which the message relates; and wherein the agent is operable to perform said determining, based at least in part on the triggering criteria of each message.

12. The system of claim 11 wherein in performing said determining, said agent determines whether at least one of said plurality of functional components satisfies the triggering criteria associated with any of said messages.

13. A system comprising:
a client system that is at least temporarily communicatively coupled via a communication network to a server system, wherein said client system comprises at least one firmware component; and
an agent executing on the client system for determining from information on said server system if any updates are available for the at least one firmware component.

14. The system of claim 13 wherein if an update is available for the at least one firmware component, said agent further executing on the client system for determining if the update is possessed by the client system.

15. The system of claim 14 wherein if the update is not possessed by the client system, said agent further executing on the client system for outputting notification of such an update being available.

16. The system of claim 13 wherein said agent further executes on the client system for accessing said server system via said communication network.

17. The system of claim 16 wherein said agent performs said accessing of said server system only if detected that the client system has a communication connection established with said communication network.

18. The system of claim 13 wherein the at least one firmware component resides on a host computer.

19. The system of claim 13 wherein said client system comprises a peripheral device coupled to a host computer, and wherein the at least one firmware component resides on said peripheral device.

20. The system of claim 13 wherein said agent is further operable to access a separate server to determine at least one network location for accessing update information for the at least one firmware component.

21. The system of claim 13 wherein said agent is further operable to trigger download of an update responsive to user input.

22. The system of claim 13 wherein agent is further operable to update the at least one firmware with a downloaded update.

23. Computer-executable software code stored to a computer-readable media, the computer-executable software code comprising:
code for accessing a server system and determining if any updates are available for firmware that is present on a client system; and
code for outputting notification on the client system that an update is available for the firmware, if determined that an update is available for the firmware.

24. The computer-executable software code of claim 23 wherein the code for accessing and the code for outputting reside on said client system.

25. The computer-executable software code of claim 23 wherein said client system comprises a host computer and at least one peripheral device communicatively coupled to the host computer.

26. The computer-executable software code of claim 25 wherein the firmware resides on the at least one peripheral device.

27. The computer-executable software code of claim 23 further comprising:
code for detecting whether said client system has a communication connection established with a communication network, wherein said code for accessing attempts to access said server only if detected that said communication connection is established.

28. The computer-executable software code of claim 23 further comprising:
code for monitoring whether said client system has a communication connection established with a communication network.

29. The computer-executable software code of claim 23 further comprising:
code for activating said code for accessing upon a communication connection with a communication network being detected for said client system.

30. The computer-executable software code of claim 23 further comprising:
code for further accessing a separate server to identify said server system possessing update information for the firmware.

31. The computer-executable software code of claim 30 wherein said code for accessing said separate server includes code for identifying a network location for said server system possessing update information for the firmware.

32. The computer-executable software code of claim 23 wherein said notification provides an interface that enables a user to select to download the available update.

33. The computer-executable software code of claim 23 further comprising:
code for updating the firmware with an available update upon the available update being downloaded to the client system.

34. A method comprising:
storing a message to a server system;
associating information with the message identifying at least one component that is to trigger presentation of the message;
determining, by an agent on a client system, from the information if any messages are available that are identified as being triggered for a component present on the client system.

35. The method of claim 34 wherein if a message is determined to be available that is identified as being triggered for a component that is present on the client system, said agent causing the message to be output on the client system.

36. The method of claim 35 further comprising:
distributing ones of said agent to a plurality of client systems for monitoring said server system for messages to be output on their respective client system.

37. The method of claim 35 further comprising:
said agent determining whether to output a message identified as being triggered for a component that is present on the client system based at least in part on a message type.

38. The method of claim 34 wherein said associating comprises:
associating information with the message identifying firmware that is to trigger presentation of the message.

39. The method of claim 34 further comprising:
including an update notification for a corresponding component in at least one of said messages.

40. The method of claim 34 further comprising:
including type information for at least one message that identifies a type of the corresponding at least one message.

41. The method of claim 40 wherein said including type information comprises:
including at least one type selected from the group consisting of: an update notification, an advertisement, a tip, a warning, a special offer, and a recall notice.

42. A method comprising:
an agent on a client system accessing information on a server system;
determining, by said agent, from said information, whether an update is available for firmware on the client system; and
if determined that an update is available for firmware on the client system, said agent causing notification of said update to be output on the client system.

43. The method of claim 42 further comprising:
said notification providing an interface that enables a user to select to have the update downloaded to the client system.

44. A client system comprising:
a plurality of functional means;
means for accessing update information on a server system;
means for determining from the update information whether an update is available for any of the functional means of the client system; and
means for providing notification on the client system of an update determined to be available for any of the functional means of the client system.

45. The client system of claim 44 wherein said plurality of functional means comprises at least one selected from the group consisting of:
a host computer, a peripheral device coupled to said host computer, firmware residing on said peripheral device, and firmware residing on said host computer.

46. A method for distributing messages to a plurality of clients to whom the messages relate, said method comprising:
storing the messages on a server;
associating a trigger criteria with each message, wherein the trigger criteria identifies at least one functional component to which the message relates; and
distributing an agent to the plurality of clients, wherein the agent is operable to periodically access the server and determine any messages for which the agent's respective client possesses the at least one functional component as specified by the message's associated triggering criteria.

47. The method of claim 46 wherein the agent is further operable to present any message determined to have its associated trigger criteria satisfied by the agent's respective client.

48. The method of claim 46 wherein said messages comprise update notifications for said at least one functional component to which the messages relate.
